(19) United States
(12) Patent Application Publication
(10) Pub. No.: US 2005/0279616 A1
(43) Pub. Date: Dec. 22, 2005

(54) Extendible conveyor system

(76) Inventor: Richard W. Pogue, Pevely, MO (US)

Correspondence Address: Henry W. Cummings, 3313 W. Adams St., St. Charles, MO, 63301, US

(21) Appl. No.: 10/870,892

(22) Filed: Jun. 18, 2004

(51) Int. Cl. B65G 15/60

(52) U.S. Cl. 198/812; 198/861.1

(57) ABSTRACT

The Extendible Conveyor System (ECS) is a system that allows material to be transported from a low plane, such as a truck bed, onto a high plane, such as a rooftop. The ECS has the ability to extend its length via the use of hydraulics thus greatly increasing its reach enabling the conveyor to carry material further distances. The material may be fed continuously at a rate selected by the operator. The ECS employs a Dual Ram Stem at its base to allow the base to raise and lower for the easier loading of material onto the conveyor at the truck bed end.

### I FIELD OF THE INVENTION

This invention relates to an Extendible Conveyor System (ECS) that allows material to be transported from a low plane, such as a truck bed, onto a high plane, such as a rooftop.

### II BACKGROUND OF THE INVENTION

U.S. Pat. No. 4,058,198 (O'Neill, Douglas, Joseph, Mallaghan and Lee, Nov. 15, 1977) is a conveyor assembly with an extension built on to it. This Patent employs two separate conveyors; a main conveyor and a secondary conveyor mounted pivotally at the forward end. The extendible conveyor system of the present invention employs one continuous conveyor, whether extended or retracted. Secondly, this patent has an in use position and an out of use position; out of use position being when the boom conveyor is accommodated under part of the main conveyor.

The extendable conveyor system of the present invention is perpetually in an in use position because it telescopes with one endless conveyor.

U.S. Pat. No. 5,685,416 (Bonnet, Nov. 11, 1997) is a conveyor assembly with an extendible boom. This Patent employs tubular steel, telescopic members requiring the roller assemblies to be mounted outside the extendible boom.

The extendible conveyor system of the present invention employs four sections of steel C-channel allowing the roller assembly to be contained internally within the frame.

Furthermore, as previously mentioned with U.S. Pat. No. 4,058,198, this Patent has an active portion and an excess belt portion.

This Patent also has a control circuit adapted to coordinate the extension of the telescoping boom with the movement of the first roller assembly with respect to the second roller assembly. The extendible conveyor system of the present invention requires no coordination between roller assemblies as it employs one continuous conveyor with all sections continuously active, whether retracted, in process of extending, or fully extended.

U.S. Pat. No. RE29,110 (Oury, Ian. 11, 1977) is a Boom mounted conveying means by which a load supporting cantilever boom contains a fixed section and a moving section mounted on a support column. This Patent employs two separate conveyors with the secondary conveyor being mounted underneath the main conveyor.

The extendible conveyor system of the present invention employs one continuous, in-line conveyor.

The present invention also employs a dual hydraulic ram stem column allowing the base end of the apparatus to be lowered to accommodate easy loading. The external dual rams also allow for an increased load and accessible maintenance. The present invention's stem column also contains a one-piece steel core that begins at the base end of the conveyor and travels downward through the truck bed and terminates at a determined distance below and underneath said truck bed, supporting the weight of the conveyor. The ECS has the ability to extend its length via the use of hydraulics thus greatly increasing its reach enabling the conveyor to carry material further distances. The material may be fed continuously at a rate selected by the operator. The ECS employs a Dual Ram Stem at its base to allow said base to raise and lower for the easier loading of material onto the conveyor at the lower end, ie. the truck bed.

### III DESCRIPTION OF THE DRAWINGS AND MAIN ELEMENTS

FIG. 1 is a side elevation view of the extendible conveyor system of the present invention with the hydraulic extension ram 28 visible. The hydraulic extension ram 28 powers the conveyor extension 2 out of the main conveyor section 4.

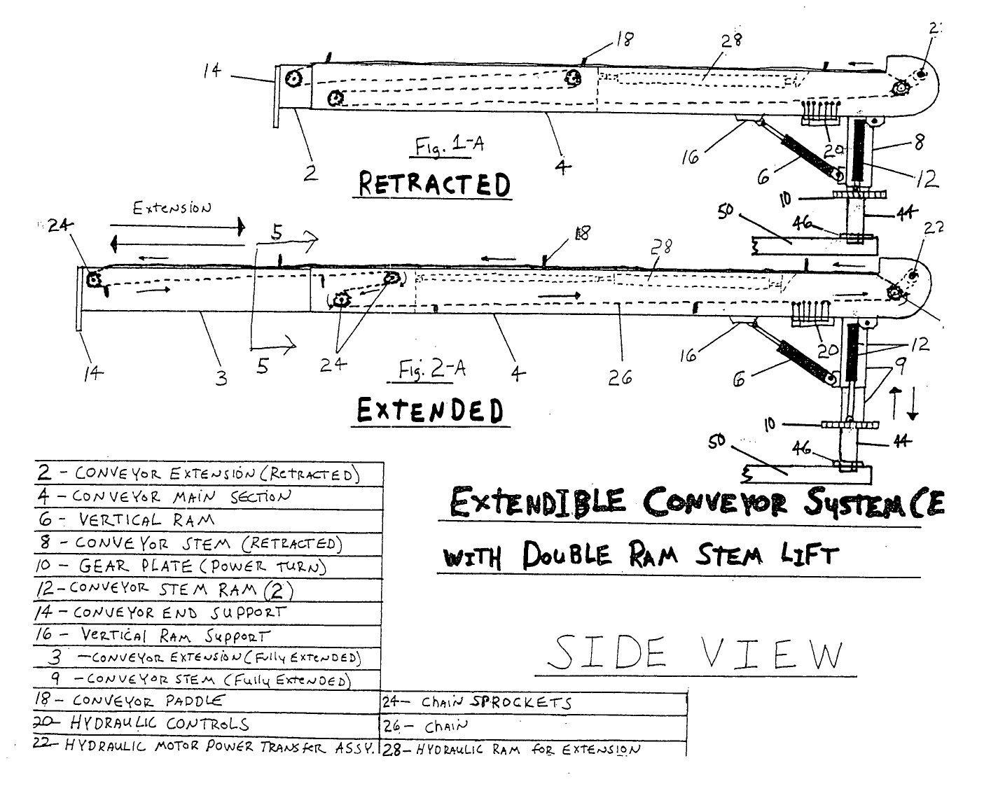

FIG. 2 is a side elevation view of the extendible conveyor system of the present invention with the conveyor extension fully extended 3. The chain/belt 26 and sprocket/roller system 24 as well as the hydraulic motor power transfer assembly 22 are visible.

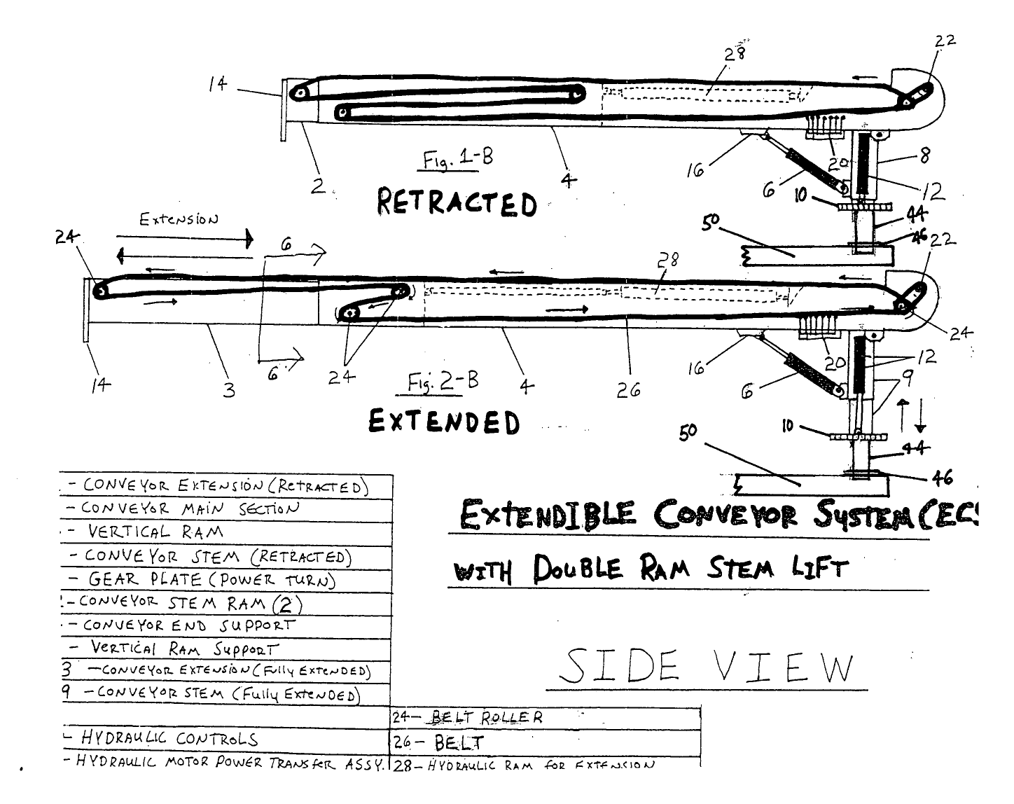

FIG. 3 is a rear elevation view of the extendible conveyor system of the present invention showing the dual lift rams 40 fully extended. The hydraulic motor 54 and the drive chain 56 provide power turn capability.

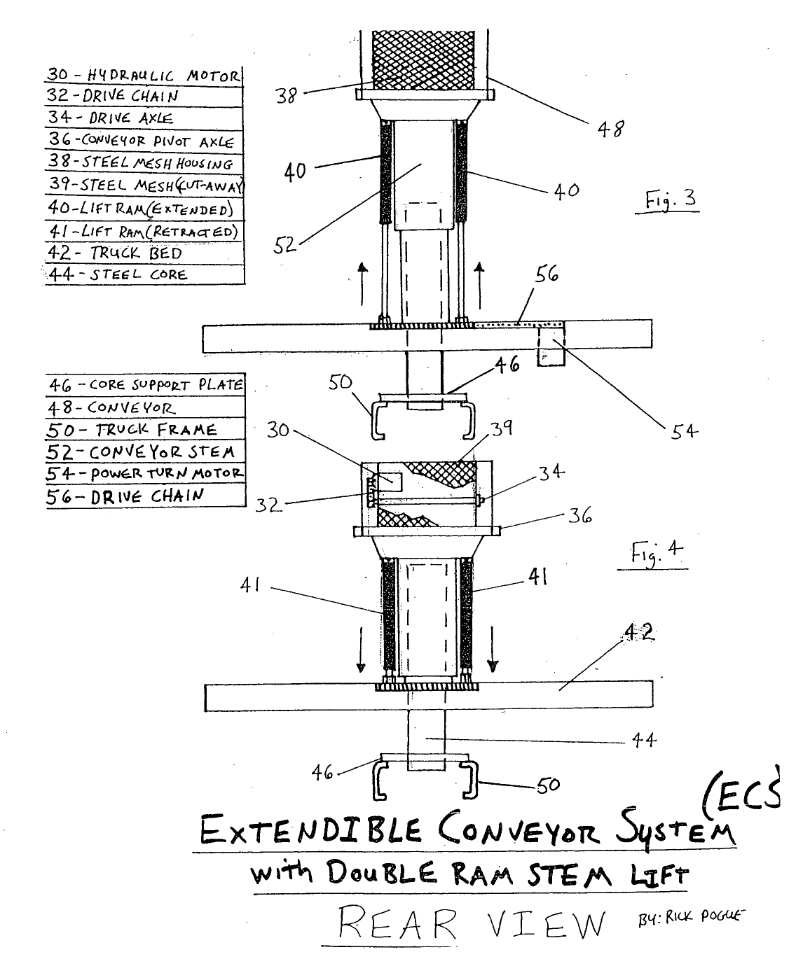

FIG. 4 is a rear elevation view of the extendible conveyor system of the present invention with the dual lift rams 41 fully retracted. The hydraulic motor 30, drive chain 32, and drive axle 34 which drive the conveyor are visible. The one˜piece steel core 44 travels through the core support plate 46, the truck bed 42 and terminates inside the conveyor stem 52. The core support plate 46 is attached to the host truck frame 50.

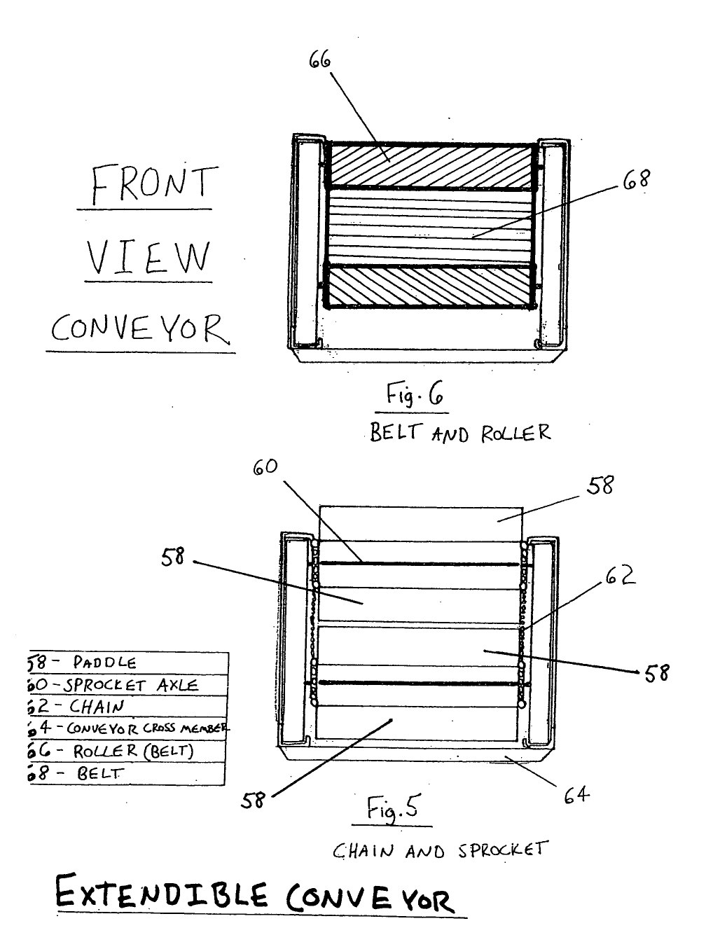

### IV SUMMARY OF INVENTION

The Extendible Conveyor System (ECS) is a system that allows material to be transported from a low plane, such as a truck bed, onto a high plane, such as a rooftop. The ECS has the ability to extend its length via the use of hydraulics thus greatly increasing its reach enabling the conveyor to carry material further distances. The material may be fed continuously at a rate selected by the operator. The ECS employs a Dual Ram Stem at its base to allow the base to raise and lower for the easier loading of material onto the conveyor at the truck bed end. by hydraulic motor 54 and driven by drive chain 56. The conveyor stem stem 52 is supported by one piece steel core 44 and core support plate 46.

1. An extendible conveyor system comprising:
A conveyor having a body portion and an extension having an end;
said conveyor also having a conveyor stem;
said extension having ability to slide in and telescope out of said body portion;
means for providing power for said sliding and telescoping movement;
means for providing power for vertical movement of said conveyor stem;
whereby said conveyor stem lowers to loadable height and said conveyor stem subsequently lifts vertically.

2. A conveyor system according to claim 1 including means for rotating said system 360 degrees.

3. A conveyor system according to claim 2 wherein the means for rotating said system 360 degrees comprises a gear plate.

4. A conveyor system according to claim 1 wherein the means for providing power for vertical movement of said conveyor stem comprises at least one hydraulic ram.

5. A conveyor system according to claim 4 wherein the means for providing power for vertical movement of said conveyor stem comprises double hydraulic rams.

6. A conveyor system according to claim 5 wherein said double hydraulic rams have support strength provided by a metal core.

7. A conveyor system according to claim 1 wherein said extension telescopes outward and retracts inward.

8. A conveyor system according to claim 7 said extension telescopes outward and retracts inward by an internally positioned hydraulic ram.

9. A conveyor system according to claim 7 including means for pushing material secured to a belt and for movement through a series of rollers and back to the original position.

10. A conveyor system according to claim 7 including means for lowering said conveyor stem to accomodate easier loading of material, and for raising said conveyor stem when the loading is complete.

11. A conveyor system according to claim 10 including, when said conveyor stem is in the lowered position, means for rotating said stem 360 degrees.

12. A conveyor system according to claim 11, wherein said means for rotating said stem 360 degrees comprise a gear plate.

13. A conveyor system according to claim 12, wherein said gear plate is powered by a motor.

14. A conveyor system according to claim 13, wherein said motor is a hydraulic motor.

15. A conveyor system according to claim 13, wherein said motor is driven by at least one drive chain.

16. A conveyor stem assembly comprising:
a vertically extending conveyor stem adapted to be connected at its upper end to a conveyor adjacent said conveyior's inner end and its lower end adapted to be attached to a truck bed;
at least one vertically extending hydraulic ram located adjacent said stem and adapted to be connected to said conveyor, said ram having a piston movable vertically therein; and
at least one diagonally extending hydraulic ram connected generally at a first end to the middle portion of said conveyor stem and connected at a second end to said conveyor laterally spaced from said conveyor stem.

17. A conveyor stem assembly according to claim 16 wherein said conveyor stem stem is supported by a metal core.

18. A conveyor stem assembly according to claim 17 wherein said metal core is supported by a transverse plate.

19. A conveyor stem assembly according to claim 16 wherein said conveyor stem stem is supported by a pair of spaced hydraulic rams.

20. A conveyor system according to claim 1 wherein said system comprises a belt drive.

21. A conveyor system according to claim 1 wherein said system comprises a chain drive.
